(19) United States
(12) Patent Application Publication
(10) Pub. No.: US 2009/0025872 A1
(43) Pub. Date: Jan. 29, 2009

(54) Method of making and using retroreflective fibers

(76) Inventors: Robert B. Nilsen, Mystic, CT (US); Gus Bernard, Ocean Ridge, FL (US); Garrett L. Nilsen, Mystic, CT (US)

Correspondence Address: William M. Hobby, III, # 375, 157 E. New England Avenue, Winter Park, FL, 32789, US

(21) Appl. No.: 11/878,811

(22) Filed: Jul. 26, 2007

(51) Int. Cl. B29C 65/00

(52) U.S. Cl. 156/278

(57) ABSTRACT

A method of making and using retroreflective fibers and especially to the making of retroreflective fibers from finely cut strips from a thin sheet of material having a corner cube array formed on one side thereof. Other layers of materials including a second thin sheet of material having a corner cube array may be attached to the first thin sheet of retroreflective material. The thin strips may be further chopped into shorter strips and added to coating compounds, such as paint.

The present invention relates to a method of making and using retroreflective fibers and especially to the making of retroreflective fibers from finely cut strips of a thin sheet of material having a corner cube array formed on one side thereof.

### BACKGROUND OF THE INVENTION

Reflective fibers for fabrics have generally been made attaching glass beads or parabolic reflectors to natural or synthetic fibers using a binder. This fiber thus has the retroreflective material exposed on the surface of the fiber, providing little protection against abrasion and degradation of the retroreflective elements. The fabric and materials made from these fibers tend to have low levels of retroreflectivity and do not have longevity in regard to retroreflection.

In addition, there exists today one generally practiced form of roadway marking for traffic that of applying roadway paint and then spreading glass beads on the wet paint surface to achieve a level of retroreflection. This practice achieves a very low level of retroreflection, and one in which the glass beads degrade, are eroded off the roadway by traffic, or as is well known with glass beads, lose their retroreflection properties when wet, such as in rainy weather when roadway illumination is most critical. A retroreflective coating is needed to ensure motorists that roadway markings illuminate and provide safe passage in darkness and during wet weather conditions.

### SUMMARY OF THE INVENTION

A method of making retroreflective fibers includes selecting a sheet of retroreflective material which has a corner cube array on one side thereof. A polymer sheet of material is laminated to the retroreflective material and a coating applied over the retroreflective material. The sheet of material is cut into thin strips or threads for forming retroreflective fibers for use in making retroreflective materials. The process can include chopping the retroreflective thread into smaller retroreflective fibers for adding to a coating material such as paint. The process may include metalizing the corner cube side of the sheet of retroreflective material and optionally laminating a second sheet of retroreflective material to the either side of the selected sheet of retroreflective material. The method of making and using the retroreflective fibers includes weaving a retroreflective thread made of retroreflective fibers and polymers to form a retroreflective fabric and optionally using the retroreflective fibers for feeding into an injection molding machine to form a retroreflective polymer. The retroreflective fibers may also be mixed with a coating material, such as paint, and applied to a roadway or any other area requiring a reflective paint. Retroreflective fibers may also be included in a polymer film or a reflective tape or retrorefelctive strands may be applied through a fiberglass gun.

It is an object of this invention to provide an improved method of marking roadways, one which provides improved retroreflection and wet weather properties.

It is another object of the present invention to provide a method of roadway marking which does not degrade or erode from the surface with the rapidity of glass beads.

It is another object of the present invention to provide a system with superior retroreflection properties, including but not limited to, brightness, entrance angles and durability.

It is also possible to produce lengths of thin retroreflective thread or retroreflective fibers, which can be clad using an extrusion machine and coated with various materials, such as polyurethane or other materials to achieve wavelength selectivity, color, phosphorescence and other application specific properties to produce reflective thread for garments and patches with both decorative and safety features.

### BRIEF DESCRIPTION OF THE DRAWINGS

Other objects, features, and advantages of the present invention will be apparent from the written description and the drawings in which:

FIG. 1 is a sectional view of a sheet of retroreflective material having a corner cube array on one side thereof;

FIG. 2 is a sectional view of two sheets of retroreflective material each having a corner cube array on one side and laminated together;

FIG. 3 is a sectional view of a sheet of retroreflective material having two sheets each having a corner cube array laminated together;

FIG. 4 is a perspective view of the laminated material of FIGS. 1, 2 and 3 cut into thin threads and being fed onto a spool;

FIG. 5 is a diagrammatic view of a plurality of spools of retroreflective threads being fed into a chopper to produce short fibers for mixing into other materials;

FIG. 6 is a diagrammatic view of the retroreflective fibers coating a polymer being fed into an injection molding machine;

FIG. 7 is an elevation view of a polymer extrusion machine for coating a wire with retroreflective fibers; and

FIG. 8 is a diagrammatic view of the coating of a central core with retroreflective fibers.

### DETAILED DESCRIPTION OF THE PREFERRED EMBODIMENT

This invention relates to a method of making retroreflective thread for use in making retroreflective cloth or patches, and to the use of the same fibers, cut into smaller lengths, for making a retroreflective material.

The invention is accomplished using retroreflective sheeting made of arrays of corner cubes, typically from 0.002 to 0.010 inches on center. This sheeting is metalized, typically with aluminum, but many other metals can be used, and may be top coated to provide a retroreflected color. Two layers of retroreflective sheeting may also be joined together with an adhesive with the tips of the metalized corner cubes embedded in the adhesive, creating a two sided retroreflector. This film of corner cubes is then slit to a width of between 0.003 and 0.020 inches and then wound up on a spool. The wound material is then fed, singularly or multiple stands together, into a chopping machine. These thin threads are now cut into a uniform length, from 0.004 to several inches and are now individual fibers. These fibers are can now be processed by mixing with paint, applied on top of wet paint, or spread onto a carrier sheet and covered with a topcoat or film and slit into roadway products, or other retroreflective or decorative products.

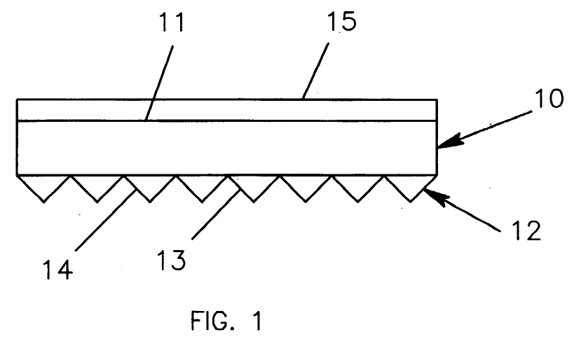

Referring to FIG. 1 of the drawings, retroreflective fibers are composed of corner cube arrays 12 which have been cast or adhered to a base film 11 or embossed onto a base film 11. The term corner cube and prism are used interchangeably, with a three sided prism capable of retroreflection commonly referred to as a corner cube. There are many variations of materials used for both the base film 11 and the prisms 13, which are included herein by reference. The prism array 12, which includes retroreflective corner cube prism elements 13, is formed on the base film 11. The base film 11 provides a smooth surface upon which the prism elements can attach, preferably to the window side of the prism elements. The prism array 12 can be laminated to the base film 11 with a transparent adhesive, or the prism array can be cast directly onto the base film using a polymer. The prism array 12 polymer is selected from a variety of polymers, which include the polymers of urethane, acrylic acid esters, cellulose esters, ethylenically unsaturated nitrile, hard epoxy acrylates, and other polymers including polycarbonates, polyesters and polyolefins, acrylated silanes and hard polyester urethane acrylates. The prism array 12 has a window side and facet sides and is attached on the window side to the base film 11. In this case the prismatic sheeting is produced on polyester film, from 0.005 to 0.20 inches in thickness and the prism material is an acrylic cured resin. The prisms 13 can be many sizes and type of corner cube, from 0.001 to several inches on center, and can have geometries that are tilted, off axis and can even be different sizes of corner cubes on the same sheet. The retroreflective structure 10 is then aluminum metalized 14 on the side of the prism array 12, and a top coat 15, or several top coats, of clear or color coatings are applied for various purposes, including colorization, UV protection, abrasion resistance, wavelength selectivity or the like on the reverse side, or top of the base film 11.

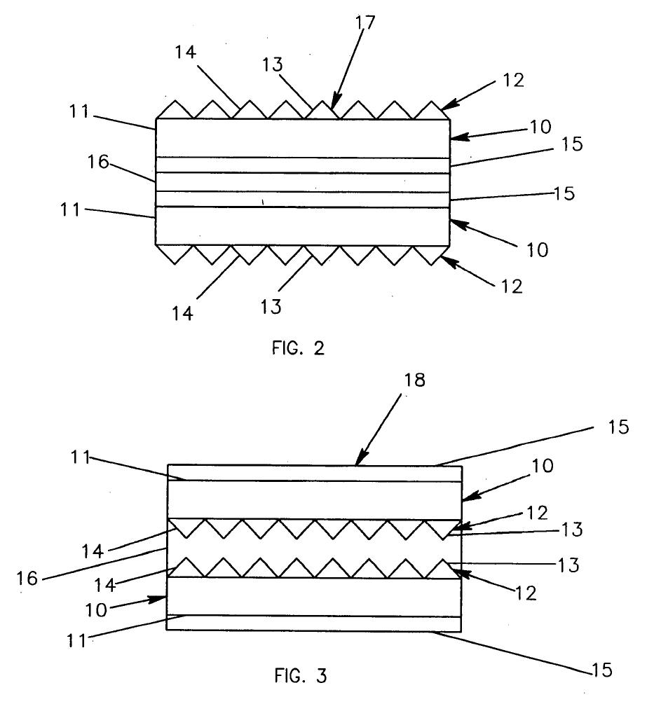

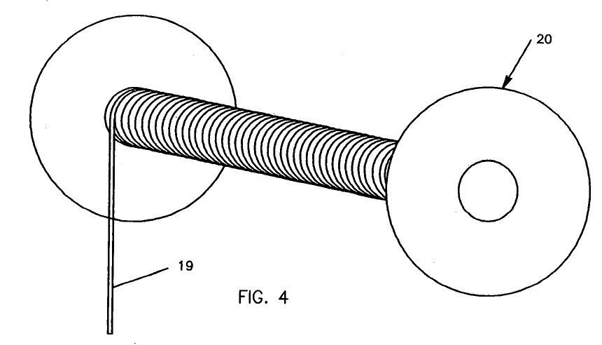

This metalized retroreflective sheeting 10 can then be laminated as shown in FIG. 2 back to back with an adhesive 16 in the center, having the tips of the corner cubes 13 facing outward away from the adhesive 16, or the sheeting can be laminated together as shown in FIG. 3 with the tips of the corner cubes 13 embedded in the adhesive 16. In this case the corner cubes are aluminum metalized 14 to provide retroreflection. Aluminum metalizing is the most common, but silver, gold, copper, or many variations and combinations of metals can be deposited on the corner cubes to provide retroreflection and protection.

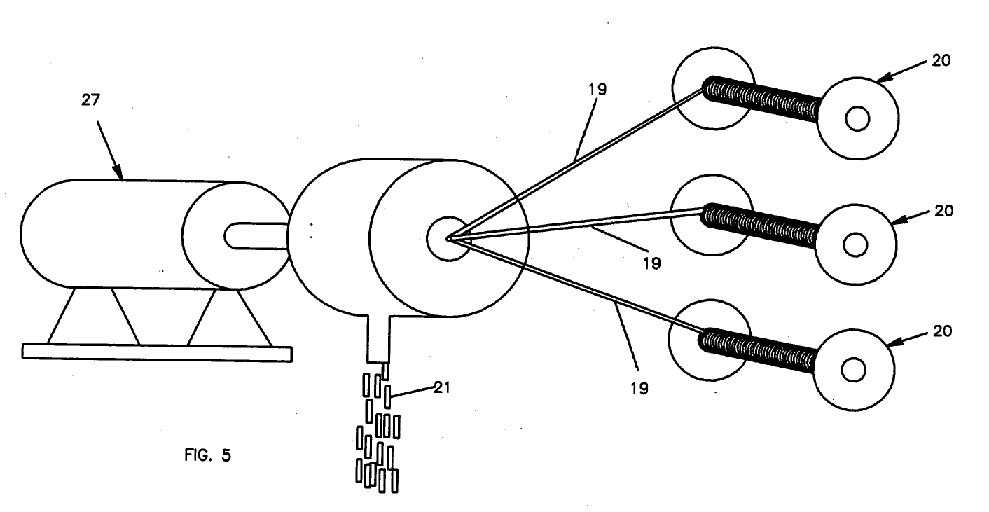

This laminated sheeting 17 in FIG. 2 or 18 in FIG.3 is then slit to a narrow width 19, as shown in FIG. 4, with width of from 0.0005 to 0.0090 inches, and wound up on a spool 20. This retroreflective spooled material 19 is then fed into a chopping apparatus 27, as shown in FIG. 5 and cut to a uniform length, from 0.005 to several inches, depending on the end use of the now short, uniform fibers 21. These fibers 21 are then collected either by gravity feed into a collection box or may be vacuumed into a collection box. At this stage of the invention we have produced fibers 21 of substantially similar length, capable of retroreflecting light on the front or the front and rear sides of the fiber. In another embodiment, a single strand of slit prism arrays 10 could be used, thus providing only a single surface of retroreflection. This single surface material can also be metalized 14 or not, and top coated 15 or not, depending on the usage of the material.

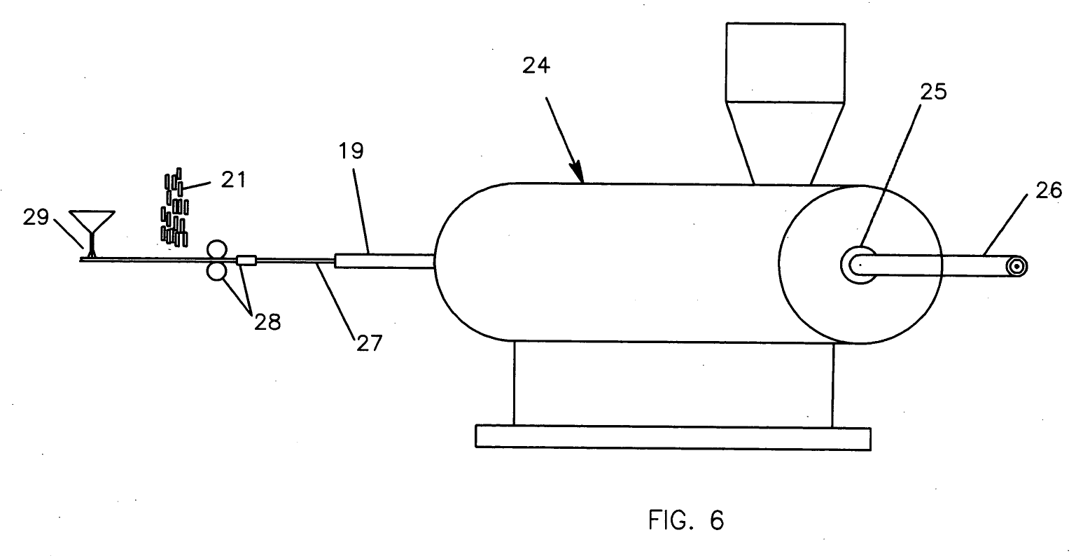

In another application, as shown in FIG. 6, a central core of wire or polymer 27 with a diameter from 0.002 to 0.010 inches may be coated with an optically clear adhesive 29. This coated core 27 is then covered with retroreflective fibers 21, the fibers being adhered to the core by rollers 28 and then fed through a die 25 in an injection molding machine 24 and a cladding formed from a polymer, such as polyurethane or any other commonly used materials. This cladding can be applied to give the fibers 26 special optical or color characteristics while also providing added tensile strength to the fibers.

At this stage, the resulting fibers 21 can be mixed into a coating 22, such as roadway paint, commonly specified by DOT offices, and applied by spray or other means to produce a retroreflective surface 23. In the case of a roadway, the fibers 21 can be applied by hand or by a machine to the top surface of freshly painted surfaces to add a retroreflective coating to the roadway.

In another application, the slit retroreflective material 19 is fed, preferably using several strands at one time through the nozzle of a fiberglass application gun, and chopped and mixed with fiberglass resin to form a molded material with a high level of retroreflection. This molded material can be used for marine, highway, personal safety or any other number of retroreflective uses.

In another application the slit retroreflective material 19 or retroreflective fibers 21 can be fed, preferably using several strands at one time through a chopping nozzle and mixed with a resin mixture of polyurea, a two part system and allowed to cure. The weathering of polyurea and its ability to adhere to metals and concrete, when mixed with the retroreflective strands will enhance the nighttime visibility of bridges and concrete roadway barriers.

In another application of the present invention, the slit retroreflective material 19 or retroreflective fibers 21 can be fed through a die 25 in an injection molding machine 24 and a cladding formed from a polymer, such as polyurethane or many other commonly used materials. This cladding can be applied to give the fiber 26 or fibers 21 special optical or color characteristics, while also providing added tensile strength to the fiber. This injection molded product may contain an internal wire or polymer string to provide increased tensile strength.

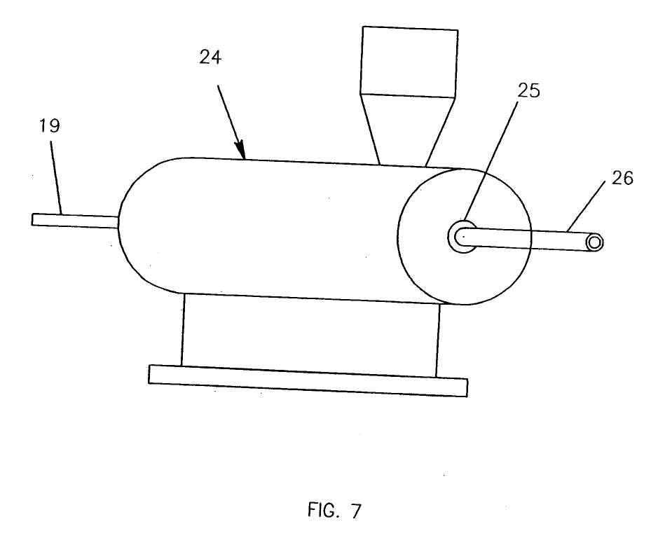

In another application as shown in FIG. 7 of the present invention, the slit retroreflective material 19 can be fed through a die 25 in an extrusion machine 24 and clad with a jacket formed from a polymer, such as polyurethane or many other commonly used materials. This coating can be applied to give the fiber special optical or color characteristics, while also providing added tensile strength to the fiber. This clad fiber 26 can then be processed through a chopping machine 27, producing fibers 21 of uniform length. These fibers 21 can then be spread on a film and coated or laminated or heat sealed using a radio frequency machine into strips, sheets, or patterns for decorative or roadway applications.

In another application, the slit retroreflective material 19, or the slit and clad retroreflective material 26, can be woven into a fabric 28 consisting of other materials, or woven using only slit retroreflective material 19 or 26 to produce a retroreflective cloth 28 or patch 28 of material. This material can be suitable for inclusion in garments such as turnout coats, sportswear, emergency personal garments and the like, where retroreflection is important for nighttime safety. The slit or slit and clad retroreflective material in fiber form may also be used to form non-woven sheeting by laying the fibers such that they overlap and then locally fusing the thermoplastic component of the fibers together under heat and pressure.

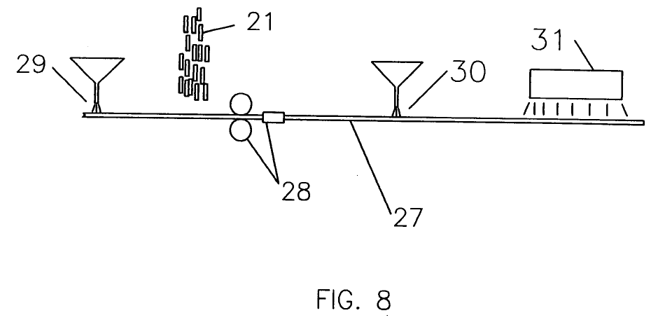

In another application, as shown in FIG. 8, a central core of wire or polymer 27 with a diameter from 0.002 to 0.010 inches may be coated with an optically clear adhesive 29. This coated core 27 is then covered with retroreflective fibers 21, the fibers being adhered to the core by rollers 28, and then coated with a UV coating 30 which may provide special optical or color characteristics while providing added tensile strength to the fiber. This coating is then cured with UV lights 31.

We claim:

1. A method of making retroreflective fibers comprising:
selecting a sheet of retroreflective material having at least one side thereof forming a corner cube array;
laminating the selected sheet of retroreflective material to a polymer sheet of material;
applying a coating over said retroreflective material; and
cutting said sheet of retroreflective material into a retroreflective thread;
whereby retroreflective fibers are formed for use to make retroreflective materials.

2. The method of making retroreflective fibers in accordance with claim 1 including the step of chopping said retroreflective thread into retroreflective fibers.

3. The method of making retroreflective fibers in accordance with claim 1 including laminating the corner cube side of said sheet of retroreflective material to a transparent sheet of material.

4. The method of making retroreflective fibers in accordance with claim 1 including the step of metalizing the corner cube side of said sheet of retroreflective material.

5. The method of making retroreflective fibers in accordance with claim 1 including the step of laminating said retroreflective sheet to a transparent polymer sheet.

6. The method of making retroreflective fibers in accordance with claim 1 including the step of applying a topcoat to said sheet of retroreflective material.

7. The method of making retroreflective fibers in accordance with claim 1 including the step of laminating two retroreflective sheets together.

8. The method of making retroreflective fibers in accordance with claim 7 including the step of laminating two retroreflective sheets together with adhesive.

9. The method of making and using retroreflective fibers in accordance with claim 1 including the step of weaving said said retroreflective thread to form a retroreflective fabric.

10. The method of making and using retroreflective fibers in accordance with claim 2 including the step of feeding said retroreflective fibers into an injection molding machine to form a retroreflective polymer.

11. The method of making and using retroreflective fibers in accordance with claim 2 including the step of mixing said retroreflective fibers with a coating material.

12. The method of making and using retroreflective fibers in accordance with claim 2 including the step of mixing said retroreflective fibers with a paint.

13. The method of making and using retroreflective fibers in accordance with claim 2 including the step of incorporating said retroreflective fibers into a polymer film.

14. The method of making and using retroreflective fibers in accordance with claim 2 including the step of feeding said retroreflective fibers or retroreflective thread through a fiberglass gun.

15. A method of making a retroreflective coating comprising:
selecting a sheet of retroreflective material having at least one side thereof forming a corner cube array; said sheet of retroreflective material being laminating to a polymer sheet of material and cut into a retroreflective thread; and
incorporating said retroreflective thread into a polymer material to make a retroreflective material.

16. A method of making a retroreflective coating in accordance with claim 15 including the step of chopping said retroreflective thread into retroreflective fibers for incorporating into a polymer material to make a retroreflective material.

17. A method of making a retroreflective coating in accordance with claim 16 including the step of mixing said retroreflective fibers into paint to form a retroreflective paint.

18. A method of making a retroreflective coating in accordance with claim 15 including the step of weaving said retroreflective fibers into a retroreflective fabric.

19. A method of making a retroreflective coating in accordance with claim 16 including the step of feeding said retroreflective fibers into an injection molding machine to form retroreflective polymer.

20. A method of making a retroreflective coating in accordance with claim 16 including the step of incorporating said retroreflective fibers into polymer film.
